(19) United States
(12) Patent Application Publication
(10) Pub. No.: US 2013/0045316 A1
(43) Pub. Date: Feb. 21, 2013

(54) Controlling Contamination on Carcasses Using Flame Decontamination

(71) Applicants: Brent Cator, Etobicoke (CA); James L. Marsden, Manhattan, KS (US); John Vatri, Mississauga (CA)

(72) Inventors: Brent Cator, Etobicoke (CA); James L. Marsden, Manhattan, KS (US); John Vatri, Mississauga (CA)

(73) Assignee: BJM FOOD TECHNOLOGIES INC., Brampton, ON (CA)

(21) Appl. No.: 13/636,254

(22) PCT Filed: Mar. 21, 2011
(86) PCT No.: PCT/US11/29162

§ 371 Date: Nov. 2, 2012

(30) Foreign Application Priority Data
Mar. 22, 2010 (US) 61316096

(51) Int. Cl. A23B 4/005

(52) U.S. Cl. 426/521

(57) ABSTRACT

A method for the decontamination of carcasses includes using a flame decontamination process in which carcasses are subjected to temperatures produced by a direct flame source for a period of time sufficient to achieve an effective degree of surface pasteurization.

This PCT international application claims priority to U.S. Ser. No. 61/316,096 filed in the U.S. Patent and Trademark Office on 22 Mar. 2010.

### I. TECHNICAL FIELD

The present invention is directed to a method for decontaminating carcasses using flame decontamination. Carcasses are subjected to temperatures produced by a direct flame source to achieve surface pasteurization.

### II. BACKGROUND OF INVENTION

The control of contamination of carcasses with Escherichia coli O157:H7 is a primary food safety objective. In 1994, the United States Department of Agriculture (USDA) Food Safety and Inspection Service established a zero tolerance policy for this organism in raw ground beef. Since contamination of beef products results from carcass contamination, a great deal of emphasis has been placed on slaughter-related interventions.

Contamination of carcass surfaces by other pathogenic organisms, such as Salmonella spp., also has regulatory and public health consequences. Hide removal and evisceration defects that occur during the slaughter process can result in pathogenic bacterial contamination that may be carried through the remaining slaughter, fabrication, and processing operations. Contamination can result in cases and outbreaks of food borne disease.

Several antimicrobial intervention technologies are available, and widely used, to effectively decontaminate carcasses (e.g., steam pasteurization, steam vacuuming, acidified rinses). However, contamination of carcasses still occurs during the slaughter process. Even low levels of contamination may increase during carcass chilling, especially if carcasses are not adequately spaced.

### III. SUMMARY OF THE INVENTION

The method of the present invention is directed to the decontamination of carcasses using flame decontamination. Carcasses are subjected to high temperatures produced by a direct flame source for periods of time required to achieve an effective degree of surface pasteurization.

An object of the present invention is to inactivate at least one of bacteria, viruses, yeast, or mold on the surfaces of the carcasses. Thus, the method of the present invention eliminates or reduces biological hazards, including microbiological pathogens, on the surface of the carcasses. This prevents or reduces the possible contamination of muscle that lies under the carcass surface.

An advantage of the present invention is that the method is a dry process and does not involve the addition of water (in the form of steam or hot water) or chemical sprays.

Another advantage of the present invention is that the method is designed to be scalable and easily implemented into existing slaughter operations.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawing, the methods should become evident to a person of ordinary skill in the art.

### IV. BRIEF DESCRIPTION OF THE DRAWING

The sole FIGURE illustrates a carcass being subjected to a flame decontamination method according to an embodiment of the present invention.

### V. DETAILED DESCRIPTION OF INVENTION

The method of the present invention is directed to the decontamination of carcasses using flame decontamination. Carcasses are subjected to temperatures produced by a direct flame source for periods of time adequate to achieve an acceptable level of surface pasteurization. For convenience, the following description uses the example of decontaminating the surface of a beef carcass. However, it will be understood that the process may be utilized on other types of meat and/or poultry carcasses.

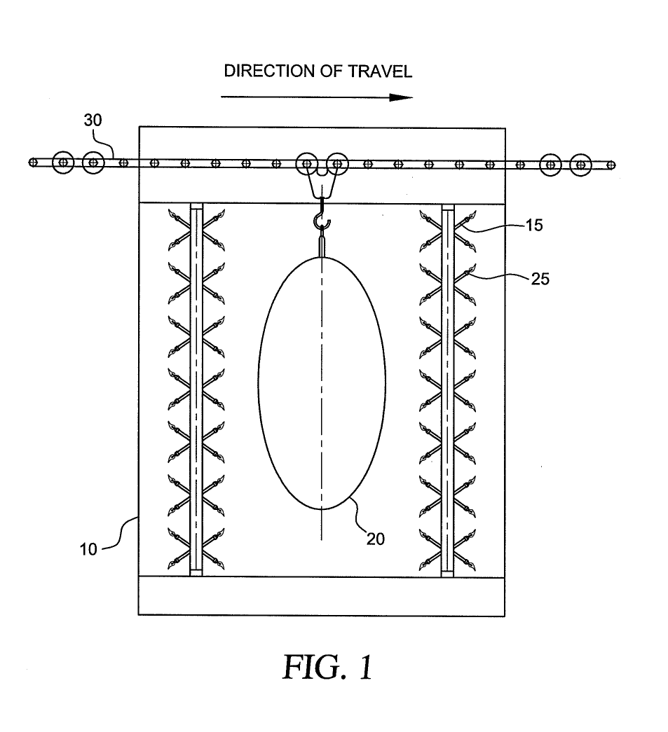

As shown in the FIG. 1, the method of the present invention utilizes a cabinet or flame chamber 10 that is equipped with at least one flame decontamination source 15 and is designed to accommodate a carcass 20. In a preferred embodiment, the cabinet or flame chamber 10 may be a stainless steel cabinet.

In specific embodiments, the flame decontamination source 15 comprises at least one nozzle 25 located at each corner of the cabinet or chamber 10. As illustrated in FIG. 1, the flame decontamination source 15 may comprise a plurality of nozzles 25 located at each corner of the cabinet 10. The flame decontamination source 15 may comprise natural gas, methane, propane, or butane.

A carcass 20, for example a split carcass, may enter the cabinet or flame chamber 10, be subjected to the flame decontamination source 15, and travel to the exit of the flame chamber in a continuous process. Thus, the method of the present invention may be advantageously incorporated into existing slaughter operations, for example, as the carcass moves through the slaughter operation via a track 30. In specific embodiments, the flame decontamination process of the present invention may be applied to a carcass immediately after the slaughter process, after cooling, or both.

The temperature generated by the flame decontamination source 15 results in the surface decontamination or pasteurization of the carcass 20. In specific embodiments, the temperature generated by the flame decontamination source 15 may be between 2800° F. to 5300° F. (1537° C. to 2927° C.). The length of time the carcass is in the cabinet may be selected based on the type of carcass, temperature, configuration of the cabinet, and integration of the decontamination method into a slaughter process. In specific embodiments, the time for the carcass to travel through the cabinet of chamber 10 may be from 5 seconds to 20 seconds, for example, from 5 seconds to 10 seconds.

The flame decontamination source 15 is positioned at a distance from the carcass sufficient to achieve surface pasteurization of the carcass 20. In specific embodiments, the flame decontamination source may be positioned from 4 inches to 12 inches (10 cm to 30.5 cm), for example, 6 inches (15.2 cm) from the surface of carcass 20.

As a result of the method of the present invention, the surface of the carcass is decontaminated or pasteurized. In addition, muscle inside the carcass is substantially free of microbiological contamination. Accordingly, the flame decontamination of the carcass surface allows for the aseptic fabrication from the treated carcass. The risk of contamination from enteric pathogens, including E. coli O157:H7, Salmonella, and Campylobacter, is greatly reduced.

In combination with good manufacturing practices and proper sanitation, the method of the present invention results in carcasses that are visually clean, and microbiological activity is minimized.

The methods of the present invention are illustrated by the following non-limiting examples.

### EXAMPLES

A. Bacterial Culture Preparation

The following strains from the Kansas State University culture collection were used to prepare an inoculum:

Escherichia coli O157:H7: ATCC 43890 and ATCC 43889, obtained from Jackie Staats at KSU Veterinary School; USDA-FSIS 380-94, KSU 01, CDC (Patient outbreak), and KSU 03, CDC (Meat outbreak).

Salmonella spp.: Salmonella choleraesuis subsp. cholerasuis (S. enteriditis) (ATCC 4931, and USDA-FSIS 15060), S. seftenburg subsp. cholerasuis (ATCC 43485), S. newport (Dr. Phebus, KSU), and S. montevideo (Dr. L. Beuchat, UGA).

To prepare the inoculum, stock cultures were cultivated by placing one impregnated bead into a 5 ml solution of Difco® Tryptic Soy Broth (TSB) and incubating for 24 hours at 35° C. Next, a 0.05 ml loop of the respective culture was inoculated into a 10 ml solution of TSB and incubated for 24 h at 35° C. All five samples from each culture were mixed together to create a 50 ml cocktail containing 10⁹ to 10¹⁰ CFU/ml of E. coli O157:H7 or Salmonella spp. The cell density of this suspensions was determined by plating appropriate dilutions on MSA (MacConkey Sorbitol Agar, Difco, Detroit, Mich.) for E. coli O157:H7 and XLD (Xylose Lysine Desoxycholate Agar, Difco, Detroit, Mich.) for Salmonella spp., and placed in the incubator for 48 hours at 35° C. Cultures were confirmed by cultivation on selective and differential media, and biochemical analysis of presumptive colonies using API 20E kits.

B. Carcass Sample Preparation

Carcass surface tissue samples were provided by the Kansas State University Meat Laboratory. Samples were frozen until time of use. The carcasses were allowed 72 hours to thaw at 45° F. (7.2° C.). Samples were inoculated with Escherichia coli O157:H7 or Salmonella spp. inside a “bio-containment” chamber by “misting” the surface of the carcass surface tissue with approximately 10 ml of the. inoculum. This was done ensuring that all sides of each sample of meat received the same exposure to the inoculum. Samples were held for 30 min. at room temperature to allow proper bacterial attachment to the surface of the meat. Immediately prior to treatment applications, the surfaces of the inoculated products were sampled and analyzed to establish the actual inoculum level of the attached organisms.

C. Sampling Method

The tissue was excised (ca. 3 mm depth) from the outside (15.9 cm²) surface of each sample and put into a stomacher bag separately. There were two core samples collected for the top and two from the bottom of each carcass tissue sample. The tissue samples were diluted with 90 ml of 0.1% sterile peptone water (PW) and homogenized in a stomacher for one minute. Samples were serially diluted in sterile PW and plated onto corresponding media for each pathogen tested. The plates were incubated at 37° C. for 48 hrs. The colony forming units (CFU) were enumerated and calculated as the difference in log recovery. Microbiological analyses were conducted using ECC (E. coli/Coliform) Petrifilm.

D. Flame Decontamination

Carcass surface tissue samples inoculated with a 5-strain cocktail of E. coli O157:H7 or a 5-strain cocktail of Salmonella spp. were treated by applying a direct flame treatment using a stainless steel food grade propane kitchen torch (Williams-Sonoma®) for a period of 10 seconds. The temperature of the flame ranged from 2800° F. to 3300° F. After treatment, the beef carcass tissue samples were tested to determine levels of each pathogen tested. Three replications of the experiment were conducted. A negative control was also conducted in three replications in which inoculated samples were untreated.

E. Results

Results are shown in the Table below. Log CFU/cm² reductions were calculated as the difference in log recoveries from the inoculated products prior to treatment and the log recovery after treatment.

The Table shows average recoveries (Log CFU/cm²) and reductions for Salmonella spp and E. coli O157:H7 on beef carcass surface tissue treated using a direct flame for a period of 10 seconds (based on three replications).

TABLE

| | | | | Reductions |
|---|---|---|---|---|
| Sample, | | | Reductions | Log |
| Flame | | | Log | CFU/cm² |
| Decontamination | | E. coli | CFU/cm² | E. coli |
| Time, sec. | Salmonella | O157:H7 | Salmonella | O157:H7 |
| 0 s | 6.9 | 6.7 | 0.0 | 0.0 |
| 10 s | 1.8 | 2.0 | 5.1 | 4.7 |

These examples demonstrate the efficacy of direct flame treatment for the surface decontamination of beef carcass tissue inoculated with Salmonella and E. coli O157:H7. Reductions of 5.1 log CFU/cm² were observed after the 10 second treatment for Salmonella and 4.7 log CFU/cm² for E. coli O157:H7. The 10 second flame treatment did not affect the appearance of the carcass tissue.

### VI. INDUSTRIAL APPLICABILITY

The method involves the decontamination of carcasses using a flame decontamination process in which carcasses are subjected to temperatures produced by a direct flame source for periods of time required to achieve surface pasteurization.

Although specific embodiments of the invention have been described herein, it is understood by those skilled in the art that many other modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

1. A method for the decontamination of a carcass, characterized by:
conveying a carcass through a chamber comprising a flame decontamination source; and
subjecting a surface of the carcass to a temperature generated from the flame decontamination source to achieve surface pasteurization of the carcass.

2. The method according to claim 1, where the carcass is a beef carcass.

3. The method according to claim 1, where the carcass is a poultry carcass.

4. The method according to claim 1 where the flame decontamination source comprises natural gas, methane, propane, or butane.

5. The method according to claim 1 where the surface of the carcass is subjected to a temperature of 2800° F. to 5300° F. (1537° C. to 2927° C.).

6. The method according to claim 1 where the surface of the carcass is subjected to the flame decontamination source for 5 seconds to 20 seconds.

7. The method according to claim 1 where the surface of the carcass is subjected to the flame decontamination source for 5 seconds to 10 seconds.

8. The method according to claim 1 where the flame decontamination source is positioned 4 inches to 12 inches (10 cm to 30.5 cm) from the surface of the carcass.

9. The method according to claim 1 where at least one of bacteria, viruses, yeast, or mold is inactivated on the surface of the carcass.

10. The method according to claim 1 where at least one microbiological pathogen on the surface of the carcass is inactivated.

11. The method according to claim 1 where E. coli O157:H7, Salmonella, and/or Campylobacter is reduced on the surface of the carcass.

12. The method according to claim 1 where the flame decontamination source is located at each corner of the chamber.

13. The method according to claim 1 where the flame decontamination source comprises a plurality of nozzles.

14. The method according to claim 1 where the method is a continuous operation.

15. The method according to claim 14, where the carcass moves through the chamber hanging on a track.

16. A method for the decontamination of a carcass, characterized by:
conveying a carcass through a chamber comprising a flame decontamination source comprising natural gas, methane, propane, or butane; and
subjecting a surface of the carcass to a temperature of 2800° F. to 5300° F. (1537° C. to 2927° C.) generated from the flame decontamination source for a period of from 5 seconds to 20 seconds to achieve surface pasteurization of the carcass.

17. The method according to claim 16 where the surface of the carcass is subjected to the flame decontamination source for 5 seconds to 10 seconds.

18. The method according to claim 16 where the flame decontamination source is positioned 4 inches to 12 inches (10 cm to 30.5 cm) from the surface of the carcass.

19. The method according to claim 16 where the flame decontamination source is located at each corner of the chamber.

20. The method according to claim 19 where the flame decontamination source comprises a plurality of nozzles.
